(19) United States
(12) Patent Application Publication
(10) Pub. No.: US 2002/0056370 A1
(43) Pub. Date: May 16, 2002

(54) Gas permeable member for hydrogen storage container

(75) Inventors: Satoru Masada, Hokkaido (JP); Yoshinori Kawaharazaki, Hokkaido (JP); Takashi Iwamoto, Hokkaido (JP)

Correspondence Address: SUGHRUE, MION, ZINN, MACPEAK & SEAS, PLLC, 2100 Pennsylvania Avenue, N.W., Washington, DC, 20037, US

(73) Assignee: THE JAPAN STEEL WORKS, LTD.

(21) Appl. No.: 09/987,403

(22) Filed: Nov. 14, 2001

(30) Foreign Application Priority Data
Nov. 15, 2000 (JP) P. 2000-347830

(51) Int. Cl. B01D 53/22

(52) U.S. Cl. 96/8; 95/55

(57) ABSTRACT

The gas permeable member makes it possible to reduce the number of fabrication steps and the fabrication cost, thereby lowering the cost. In addition, the gas permeable member exhibits excellent gas permeability and excels in durability. Further, the gas permeable member exhibits the effect of alleviating the buildup of stress in a hydrogen storage container due to the expansion of a hydrogen storage alloy.

### CROSS REFERENCE TO THE RELATED APPLICATION

The present invention is based on Japanese Patent Application No. 2000-347830, which is incorporated herein by reference.

1. Field of the Invention

The present invention relates to a gas permeable member used for a hydrogen storage container for accommodating hydrogen and extracting it the outside, as desired.

2 Description of the Related Arts

Since a hydrogen storage alloy undergoes the reaction of absorbing or releasing only hydrogen gas while accompanying heat absorption or generation, various systems which make use of this reaction, including heat pump recovery, refining, storage, and transport, have been proposed.

It should be noted that since the hydrogen storage alloy has a characteristic that the hydrogen storage alloy, if oxidized by oxygen in the air, ceases to absorb hydrogen, and since a pressure difference is required for the absorption and release of hydrogen, the hydrogen storage alloy needs to be accommodated in a container in which it is hermetically sealed. In addition, a structure for effecting heat exchange between the hydrogen storage alloy and a heating/cooling medium is required for the recovery of reaction heat and for heating or cooling the alloy.

As a method of accommodating the hydrogen storage alloy in a container, as shown in FIG. 10, the hydrogen storage alloy is accommodated in a hermetic chamber 10, plate fins 11 which are partially in contact with hermetic chamber walls are disposed in the hermetic chamber 10, and medium layers 12 where a heat medium moves are provided on outer walls of the hermetic chamber 10. In addition, to allow the movement of process by or released from the hydrogen storage alloy to be effected smoothly, sheet-like gas permeable members 13 are disposed in the hermetic chamber 10. The gas permeable members 13 are respectively connected communicatably to a base portion (not shown) provided outside the hermetic chamber 10, allowing hydrogen gas to flow out to or flow in from the outside.

It should be noted that the aforementioned sheet-like gas permeable member 13 is fabricated by superposing two or three wire nets of about 30 to 80 mesh and covering outer sides of the superposed assembly with a cloth sheet, and the sheet-like gas permeable members 13 are arranged along the planar direction of the plate fins 11. The above-described structure for accommodating the hydrogen storage alloy is called a plate fin structure.

In addition to the above-described accommodating method, there is a method in which, as shown in FIG. 11, the hydrogen storage alloy is accommodated in a multiplicity of juxtaposed tubes 15 (only one tube is shown in the drawing), the movement of hydrogen is caused to take place within the tubes 15, the heat medium is moved on the outer sides of the tubes 15, and the movement of heat is effected between the heat medium and the hydrogen storage alloy through the wall of each tube 15. It should be noted that to make smooth the movement of hydrogen gas inside each tube 15, a wire-like gas permeable member 16 is disposed in the tube 15. The gas permeable member 16 is fabricated by covering a foam nickel or wire net or the like, which constitutes a core 16a, with a sheet 16b of cotton cloth or the like, and is arranged along the axial direction of the tube 15. The respective tubes 15 are connected to an unillustrated base portion, and the base portion and the gas permeable members 16 communicate with each other, allowing hydrogen gas to flow out to or flow in from the outside through the base portion.

However, since the above-described gas permeable member is fabricated by covering the core with the sheet of cotton cloth or the like, the operation of cutting the core and the sheet and sewing together after the covering of the core with the sheet involves time and labor, so that the fabrication cost has not necessarily been low.

In addition, with the conventional hydrogen storage container, the stress load on the container, which is due to the effect of an increase in bulk density accompanying the pulverization of the alloy caused by the expansion of the alloy owing to the absorption of the hydrogen gas by the hydrogen storage alloy and the repetition of absorption and release, has been a problem.

As for the problem that the stress load is applied to the container due to the expansion of the alloy and the increase in its bulk density, it suffices if the container itself can be made of a highly rigid material and constructed into a highly rigid structure, but there is a demand for a lightweight and compact hydrogen storage container, so that this method is not appropriate. In addition, a method in which the amount of alloy filled in the container is reduced is one measure to alleviate the buildup of stress in the container; however, since this causes a decline in the storage density of hydrogen from a present level, this is not realistic.

Further, a method in which the initial particle size of the alloy filled in the container is made small in advance is one measure, but this method has problems in that it involves a greater number of alloy pulverization steps and leads to higher cost, and that the bulk density of the alloy becomes large when the alloy is filled in the container, making it difficult to fill a necessary amount of alloy in the container.

### SUMMARY OF THE INVENTION

The present invention has been devised on the basis of the above-described circumstances, and the object of the present invention is to provide a gas permeable member which facilitates fabrication and excels in gas permeability when the gas permeable member is disposed in the hydrogen storage container, and which makes it possible to effectively alleviate the buildup of stress in the container occurring in consequence of the absorption and release of hydrogen.

To overcome the above-described problems, in accordance with a first aspect of the invention, there is provided a gas permeable member for a hydrogen storage container which together with a hydrogen storage alloy is accommodated in a hydrogen storage container, comprising: a tubular member having a tubular wall formed of a woven fabric of inorganic fibers excluding metal fibers, the tubular member having a tube hole assigned to a gas passage.

In accordance with a second aspect of the invention, in the gas permeable member for a hydrogen storage container according to the first aspect, the inorganic fibers are glass fibers.

In accordance with a third aspect of the invention, in the gas permeable member for a hydrogen storage container according to the first or second aspect, the tubular wall has voids which exhibit gas permeability in a direction of wall thickness, are of such a size as not to allow pulverized hydrogen storage alloy to pass therethrough, and penetrate in the direction of the wall thickness.

In accordance with a fourth aspect of the invention, in the gas permeable member for a hydrogen storage container according to any one of the first to third aspects, the gas permeable member is applied to a heat exchanger of one of a plate fin structure and a tube incorporating type.

As described above, the gas permeable member in accordance with the invention is used for a hydrogen storage container, and can be applied to a hydrogen storage container of various applications in which hydrogen is temporarily or continuously absorbed or released. However, the invention is not limited to a hydrogen storage container whose application is specified.

In addition, in the invention, the structure of the hydrogen storage container is not limited to a specific one, and it is possible to cite the structure of a plate fin structure and the structure of a tube incorporating type.

As described above, the gas permeable member of the invention comprises a tubular member having a tubular wall formed of a woven fabric of inorganic fibers, and a tube hole of the tubular member is assigned to a gas passage. Further, meshes in the woven fabric form voids which penetrate in the direction of the wall thickness in the tubular wall, thereby securing the permeation of the hydrogen gas in the direction of the thickness of the tubular wall. In addition, apart from the aforementioned meshes, it is possible to provide voids by such as boring in the woven fabric. The aforementioned voids should preferably be of such a size that the pulverized hydrogen storage alloy does not pass therethrough.

It should be noted that, as described above, the gas permeable member in accordance with the invention is formed of a woven fabric of inorganic fibers excluding metal fibers. Metal fibers are excluded as the inorganic fibers, and it is possible to use carbon fibers or glass fibers are used, but glass fibers are preferably used.

Furthermore, in the invention, the size of the inorganic fibers, the size of the mesh and the like are selected, as required. These conditions are determined by taking into account the strength and flexibility of the tubular member, permeability of hydrogen gas, and the requirement that the pulverized alloy does not pass through the meshes. In addition, the woven fabric may be formed by disposing inorganic fibers a plurality of layers. In this case as well, it is necessary that voids penetrating in the thickness direction be secured by such as the overlapping of the meshes, thereby satisfactorily maintaining the gas permeability in the thickness direction of the tubular wall when the woven fabrics are formed into the tubular member. Further, the size of the voids should preferably be determined such that the pulverized hydrogen storage alloy does not pass through the voids. These voids should preferably be distributed in a large number in the planar direction of the fabric irrespective of whether the inorganic fiber is formed in a single layer or a multiplicity of layers. More preferably, the voids should be distributed uniformly.

In addition, although the outer shape and the inner shape of the tubular member are not particularly limited, a hollow cylindrical shape is normally used, and its inside and outside diameters may be determined by taking into account the relationship with the size of the hydrogen storage container, as well as the strength and gas permeability of the gas permeable member itself, the size of the gas passage, and the like. It should be noted that a spring or a metal foam may be inserted in the tubular member for the purpose of reinforcement.

As compared with a conventionally used sheet-like gas permeable member, the gas permeable member of the invention having the above-described construction facilitates fabrication, and makes it possible to reduce the number of fabrication steps and the fabrication cost. It is possible to reduce the area occupied by the gas permeable member as compared with the conventional sheet-like gas permeable member, and it is possible to increase the amount of hydrogen storage alloy filled in the container. Moreover, since the carbon fibers or the glass fibers constituting the tubular member have appropriate strength and are flexible, the gas passage is positively secured, it is possible to alleviate the stress occurring due to the expansion of the hydrogen storage alloy accompanying the absorption of hydrogen, thereby preventing the buildup of stress in the container wall. In addition, although heat absorption or dissipation occurs in the absorption of release of hydrogen, and the alloy is heated to 100° C. or thereabouts depending on the type of alloy, inorganic fibers excluding metal fibers exhibit high durability with respect to thermal change, and do not generate impurity gases which are likely to exert an adverse effect on the alloy. Accordingly, the inorganic fibers exhibit high durability even with respect to repeated absorption and release of hydrogen (e.g., 1000 cycles or more) without impairing the gas permeability and hydrogen-absorbing and -releasing performance.

The gas permeable member in accordance with the invention is accommodated in the above-described hydrogen storage container of the plate fin structure or the tube incorporating type. At that time, a plurality of gas permeable members may be between plate fins and between tubes. In that case, it is possible to adjust the number of gas permeable members disposed or their pitches in correspondence with the rate of hydrogen gas absorbed or released per unit time which is required.

It should be noted that both ends or one end of the end portions of the gas permeable member should preferably be provided with blank caps, as required, by means of thermal fusion, sewing, or epoxy-based adhesive agent or the like so as to prevent the mixing in of the alloy.

### BRIEF DESCRIPTION OF THE DRAWINGS

FIG. 1 is a perspective view illustrating a gas permeable member for a hydrogen storage container in accordance with an embodiment of the invention;

FIG. 2 is a partial cross-sectional view of a hydrogen storage alloy storage container of a plate fin structure to which the gas permeable members in accordance with the embodiment of the invention are applied;

FIG. 3 is a partial cross-sectional view of an example in which the gas permeable member in accordance with the embodiment is accommodated in a tube of a hydrogen storage alloy storage container of a tube incorporating type;

FIG. 4 illustrates test results of a hydrogen permeability (amount of process) evaluation test of the invention;

FIG. 5 illustrates test results of a hydrogen permeability (rate of process) evaluation test of the invention;

FIG. 6 illustrates test results of a container strain measurement test in a comparative example (alloy packing density: 2.8 g/cm³);

FIG. 7 illustrates test results of a container strain measurement test in an example (alloy packing density: 2.8 g/cm³);

FIG. 8 illustrates test results of a container strain measurement test in a comparative example (alloy packing density: 3.0 g/cm³);

FIG. 9 illustrates test results of a container strain measurement test in an example (alloy packing density: 3.0 g/cm³);

FIG. 10 is a partial cross-sectional view of a conventional hydrogen storage alloy storage container of a plate fin structure; and

FIG. 11 is a partial cross-sectional view of a tube of a conventional hydrogen storage alloy storage container of a tube incorporating type.

### DETAILED DESCRIPTION OF THE PREFERRED EMBODIMENT

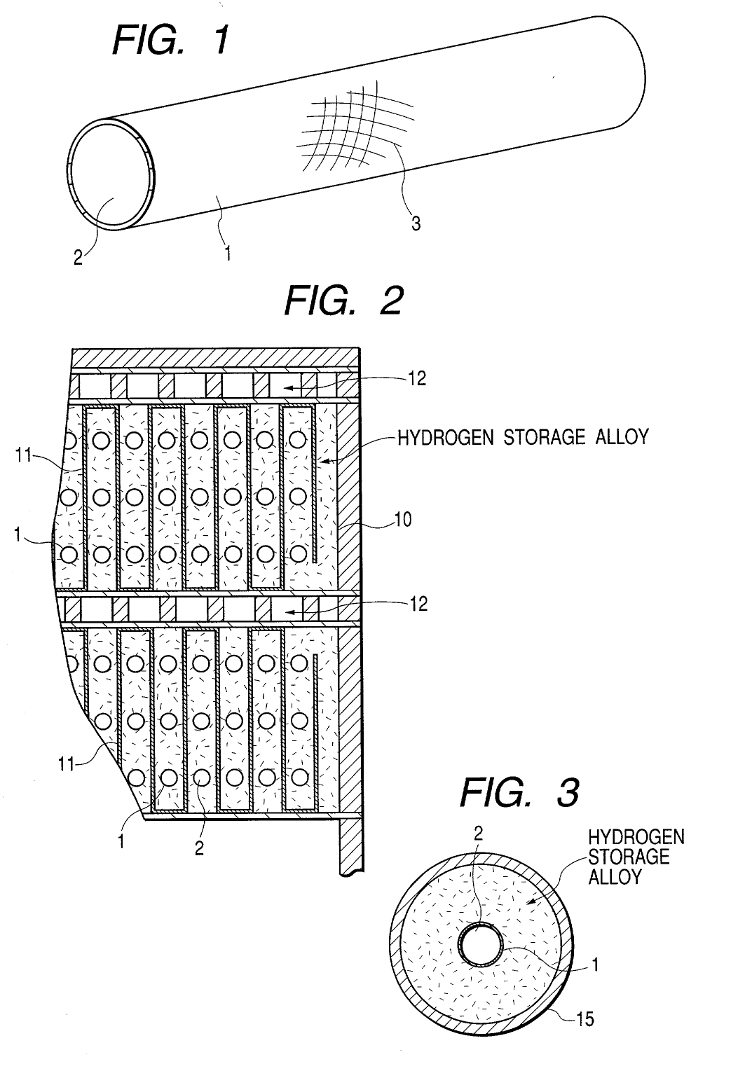

Referring now to FIGS. 1 and 3, a description will be given of a first embodiment of the invention.

As shown in FIG. 1, a gas permeable member 1 is constituted by a tubular member formed of a woven fabric made of glass fibers, its tube hole is assigned to a gas passage 2, the permeation of hydrogen is secured through meshes 3 in a tubular wall, and the meshes 3 are of such a size that the pulverized hydrogen storage alloy cannot pass therethrough.

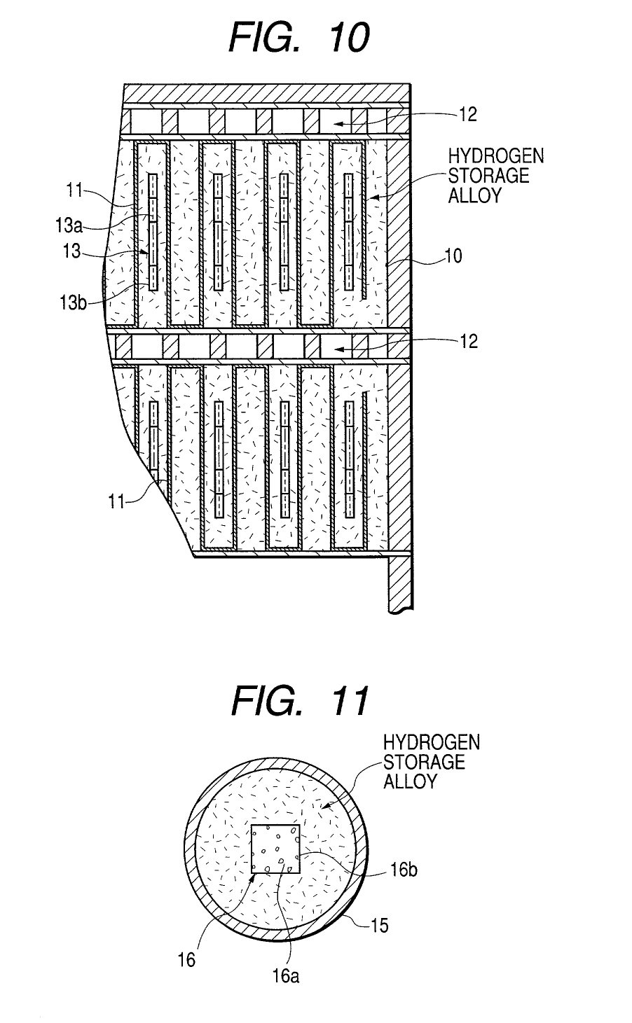

As shown in FIG. 2, this gas permeable member 1 is accommodated in a hydrogen storage container of the plate fin structure. It should be noted that components or portions similar to those of the conventional structure shown in FIG. 10 will be denoted by the same reference numerals, and a description thereof will be omitted or simplified.

The hydrogen storage alloy powder is arranged in a hermetic chamber 10, and plate fins 11 are disposed in the hermetic chamber 10. The above-described gas permeable members 1 are arranged along the axial direction in the respective gap between the plate fins 11.

In this hermetic chamber 10, at the time of heating or cooling, a necessary heat medium is allowed to flow through heat medium layers 12, and its heat is transmitted from the wall surfaces of the hermetic chamber 10 to the plate fins 11 and further to the hydrogen storage alloy, thereby heating or cooling the hydrogen storage alloy.

When the hydrogen storage alloy is heated, hydrogen is released from the hydrogen storage alloy, hydrogen passes through the meshes 3 of the gas permeable members 1, reaches the tube holes 2 of the gas permeable members 1, further advances in the axial direction through the tube holes 2, reaches a desired base portion or the like, and is sent to an external hydrogen utilizing portion or the like. On the other hand, when hydrogen is absorbed by cooling or the like, hydrogen supplied from the outside passes through the tube hole 2, further passes through the meshes 3, reaches the interior of the hydrogen storage alloy, and is absorbed by the alloy. At the time of this absorption, particularly in a case where the pulverization of the alloy has advanced, the expansion of the volume of the alloy takes place on a large scale, but the expansion is absorbed as the tubular wall of the gas permeable member 1 becomes slightly deformed. In addition, the degree of its deformation is such that the cross-sectional area of the tube hole of the gas permeable member is not narrowed more than is necessary. Consequently, the buildup of stress in the walls of the plate fins 1 without impairing the gas permeability.

In addition, even if the gas permeable member 1 is repeatedly subjected to a heat history of heating and cooling, the denaturing or deterioration of the gas permeable member 1 is small, and it is possible to maintain the performance over a long period of time. In addition, when the hydrogen storage alloy has become fine powder, the fine powder of hydrogen storage alloy does not pass through the meshes 3 to hamper the gas permeability.

Next, FIG. 3 shows an example in which the above-described gas permeable members 1 are applied to a hydrogen storage alloy storage container of a tube incorporating type. It should be noted that components or portions similar to those of the conventional structure shown in FIG. 11 will be denoted by the same reference numerals, and a description thereof will be simplified.

The hydrogen storage alloy powder is accommodated in a tube 15, and the gas permeable member 1 is accommodated in the tube 15. In the same way as the conventional structure, a multiplicity of tubes 15 are juxtaposed, and a necessary heat medium moves between them to effect transfer or reception of heat (heating or cooling).

In the tube 15, in the same way as the above-described plate fin structure, when hydrogen is released from the hydrogen storage alloy by heating or the like, hydrogen passes through the meshes 3 of the gas permeable member 1, reaches the tube hole 2 of the gas permeable member 1, further advances in the axial direction through the tube hole 2, reaches a desired base portion or the like, and is set to an external hydrogen utilizing portion. On the other hand, when hydrogen is absorbed by cooling or the like, hydrogen which passed through the tube hole 2 passes through the meshes 3, reaches the interior of the hydrogen storage alloy, and is absorbed by the alloy. In this tube incorporating type as well, the expansion of the volume of the alloy is effectively absorbed by the deformation of the gas permeable member 1.

### EXAMPLES

Hereafter, a description will be given of a test for evaluating the gas permeable member in accordance with the invention.

(1) Hydrogen Permeability Evaluation Test

This test was conducted to evaluate the hydrogen permeability. In the test, stainless steel pipes with an outside diameter of 12.7 mm, a wall thickness of 1.0 mm, and a length of 650 mm were used as hydrogen storage containers, a TiZr-base hydrogen storage alloy was filled in them, and two kinds of gas permeable member in accordance with the invention (glass fiber-made tubular members, a coil spring was inserted in one of them) were accommodated as gas permeable members. It should be noted that the amount of alloy accommodated in the case of the tubes made of glass fibers alone was 189 g, and the amount of alloy accommodated in the case of the tubes with coil springs inserted therein was 165.4 g.

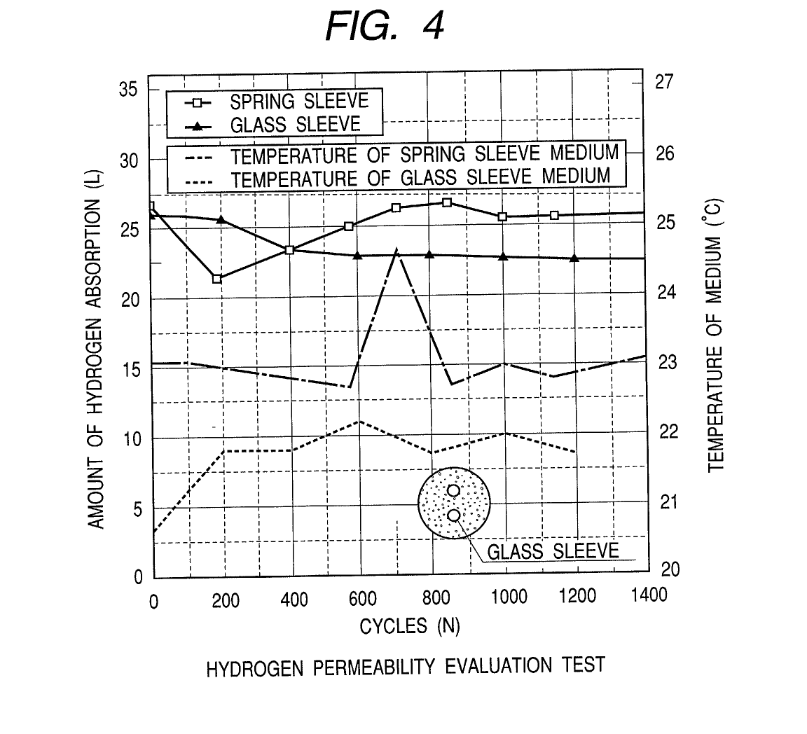

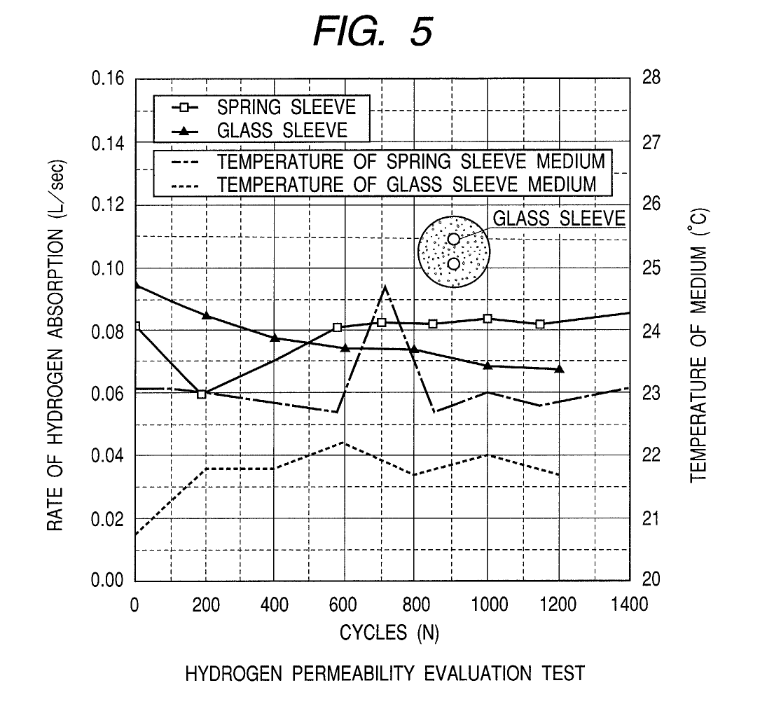

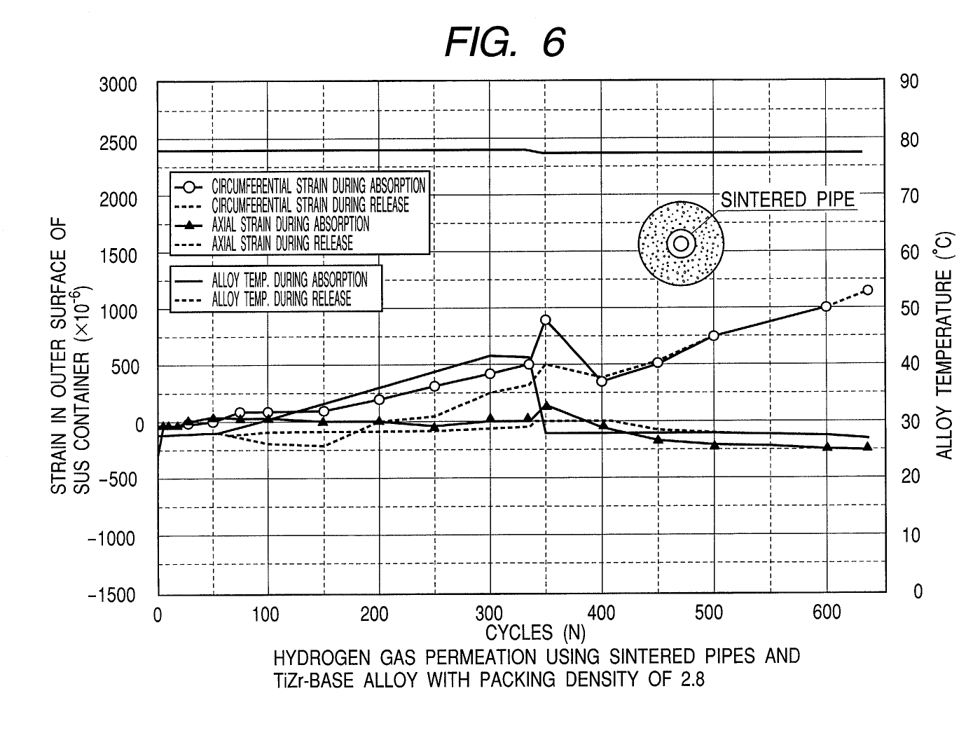

By using these hydrogen storage containers, hydrogen gas was absorbed and released by more than 1000 cycles, and changes in the amount of process and the absorption rate were measured. The results are shown in FIGS. 4 and 5. As is apparent from these drawings, the hydrogen storage containers using the gas permeable members in accordance with the invention exhibit excellent hydrogen permeability characteristics, and the tendency in which their hydrogen permeability characteristics substantially decline was not observed even with an increase of the cycle. Namely, it can be seen that the gas permeable members in accordance with the invention exhibit excellent characteristics as gas permeable members, and possess excellent durability in the repeated absorption and release of hydrogen as well.

(2) Results of Test for Measuring the Expansion of the Volume of the Alloy

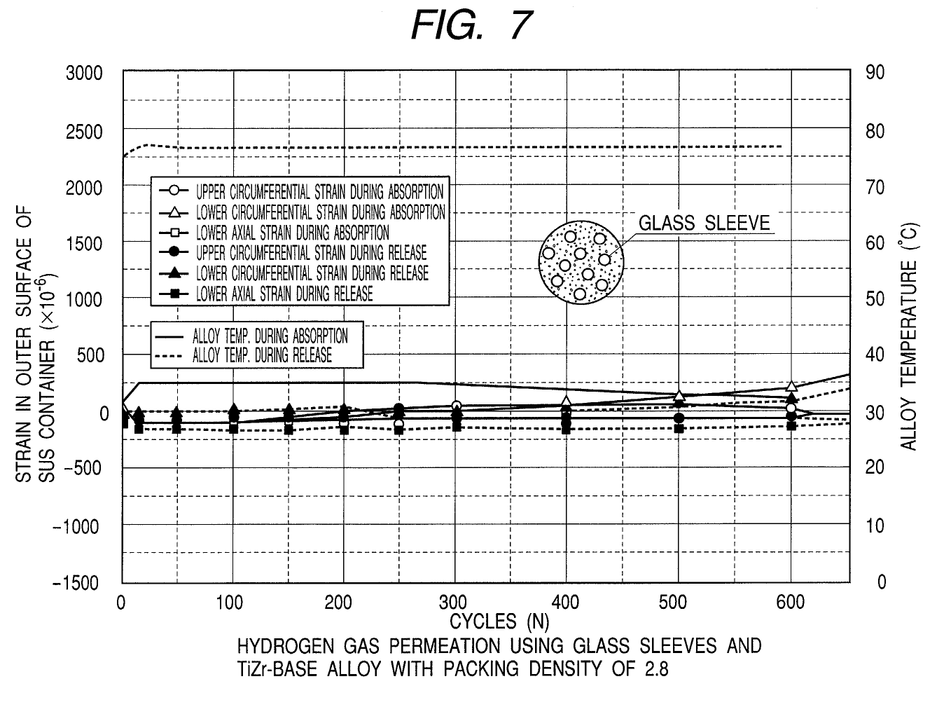

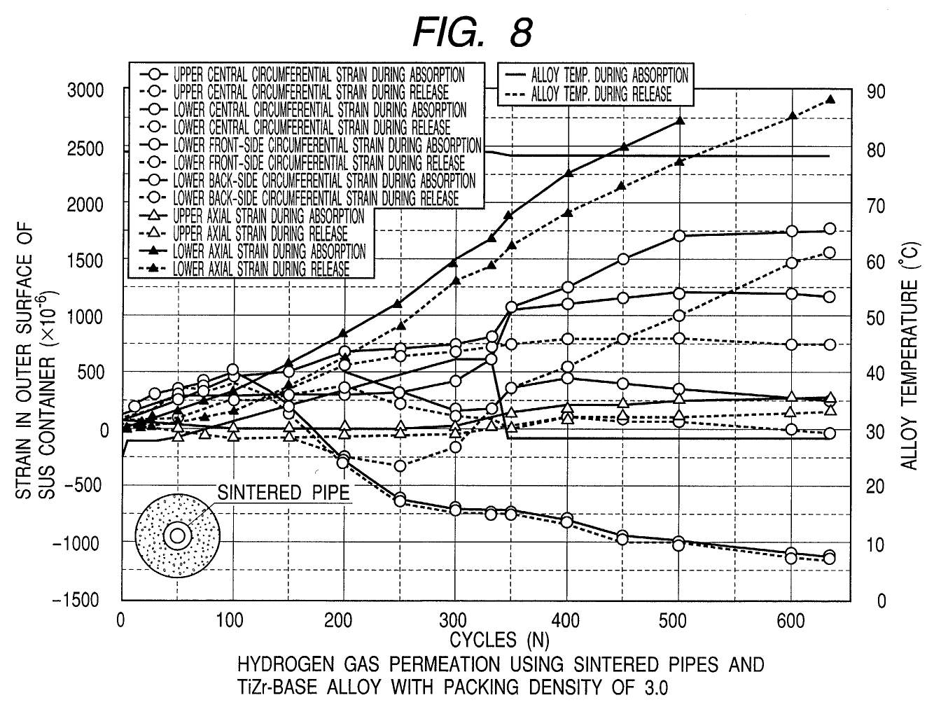

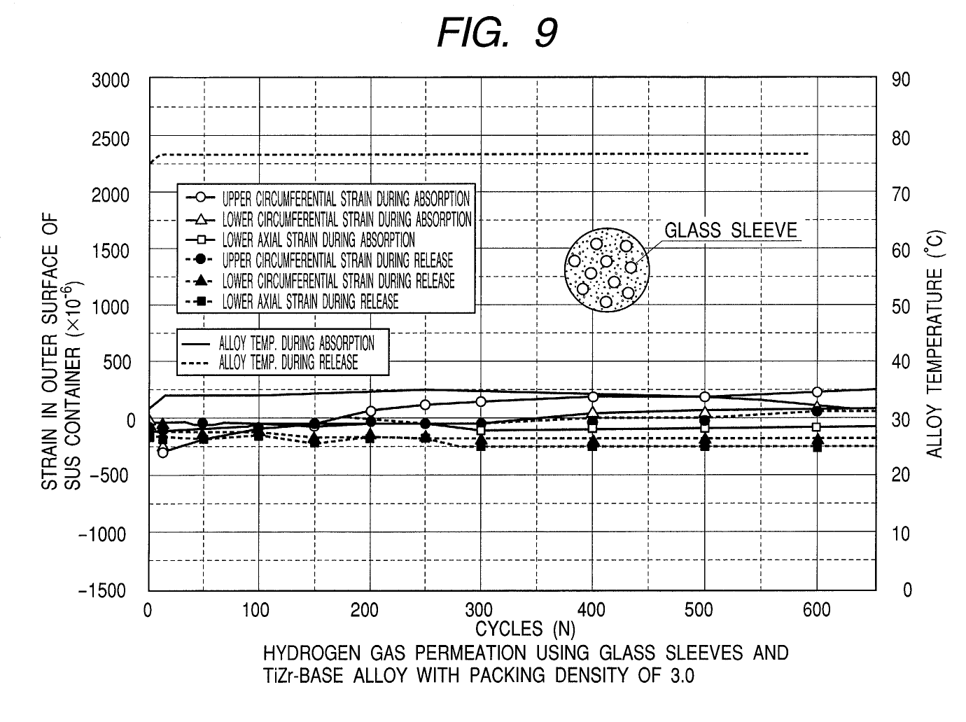

Next, evaluation was made of the effect exerted y a change in the volume of the alloy accompanying the absorption and release of hydrogen on the change in the strain of the hydrogen storage container. In this test, stainless steel pipes with an outside diameter of 19 mm, a wall thickness of 1.0 mm, and a length of 100 mm were used as hydrogen storage containers, and a TiZr-base hydrogen storage alloy was filled in them. Further, as comparative members, 10 porous sintered pipe gas permeable members (made of foam Ni, and 6.35 mm in diameter) were accommodated in them, while as the members of the invention, 10 glass fiber-made tubular gas permeable members with an outside diameter of 1.8 mm and an inside diameter of 1.0 mm were accommodated in them. In addition, at that time, evaluation was made by varying the packing density of the alloy in the stainless steel pipes (packing density: 2.8 g/cm³, 3.0 g/cm³). In addition, a strain gage was attached to the outer periphery of each stainless steel pipe to compare the buildup of stress in the container due to a change in the volume of the alloy by type of gas permeable member. The results are shown in FIGS. 6 to 9.

In consequence, as is apparent from the drawings, with the hydrogen storage containers using the sintered pipes as the gas permeable members, the strain in the containers increases substantially with an increase of the cycle, and it was found that if, in particular, the packing density of the alloy increases, the strain becomes more noticeable.

On the other hand, with the hydrogen storage containers using the gas permeable members in accordance with the invention, no major change was noted in the strain even with an increase of the cycle, and there is no great difference even if comparison is made by type of packing density of the alloy. Thus, it became clear that the use of the gas permeable members of the invention exhibits the action of absorbing the volume expansion due to the pulverization of the alloy and of alleviating the buildup of stress in the container, and that it is possible to accommodate the alloy in the container with higher packing density.

As described above, in accordance with the gas permeable member for a hydrogen storage container, since the gas permeable member together with a hydrogen storage alloy is accommodated in a hydrogen storage container, and the gas permeable member is comprised of a tubular member having a tubular wall formed of a woven fabric of inorganic fibers excluding metal fibers, the tubular member having a tube hole assigned to a gas passage, it becomes possible to reduce the number of fabrication steps and the fabrication cost in manufacturing. In addition, since a gas passage is sufficiently secured, the gas permeability increases, and since the area occupied by the gas permeable member is decreased, it becomes possible to increase the amount of hydrogen storage alloy filled in the container. Further, the gas permeable member exhibits excellent gas permeability over a long period of time, and effectively prevents the buildup of stress due to the expansion of the hydrogen storage alloy in the container wall of the hydrogen storage container.

What is claimed is:

1. A gas permeable member for a hydrogen storage container which together with a hydrogen storage alloy is accommodated in a hydrogen storage container, comprising:
a tubular member having a tubular wall formed of a woven fabric of inorganic fibers excluding metal fibers, said tubular member having a tube hole assigned to a gas passage.

2. A gas permeable member for a hydrogen storage container according to claim 1, wherein said inorganic fibers are glass fibers.

3. A gas permeable member for a hydrogen storage container according to claim 1, wherein said tubular wall has voids which exhibit gas permeability in a direction of wall thickness, are of such a size as not to allow pulverized hydrogen storage alloy to pass therethrough, and penetrate in the direction of the wall thickness.

4. A gas permeable member for a hydrogen storage container according to claim 1, wherein said gas permeable member is applied to a heat exchanger of one of a plate fin structure and a tube incorporating type.
